(19) United States
(12) Patent Application Publication
(10) Pub. No.: US 2020/0118080 A1
(43) Pub. Date: Apr. 16, 2020

(54) TIME-SENSITIVE ANALYSIS FOR IDENTIFYING RESOURCES TO RESOLVE A REQUIREMENT

(71) Applicant: INTERNATIONAL BUSINESS MACHINES CORPORATION, ARMONK, NY (US)

(72) Inventors: Carlos D. De Souza, Campinas (BR); Cesar Penna Santana, Campinas (BR); Paulo H. Paulin, FLORIANOPOLIS (BR); Marco Aurelio Stelmar Netto, Sao Paulo (BR)

(21) Appl. No.: 16/156,406

(22) Filed: Oct. 10, 2018

(51) Int. Cl. G06Q 10/10; G06F 17/30; G06Q 10/06

(52) U.S. Cl. CPC G06Q 10/105; G06Q 10/063112; G06F 17/30554; G06F 17/30342

(57) ABSTRACT

A system and method are provided for identifying resources to resolve a requirement. A computer generates an index using user information representative of a predetermined set of actions by a plurality of users of an organization and profile information for the plurality of users. The computer generates a plurality of rich profiles for the users of the organization based on the index and the user information and stores the index and the rich profiles on a software module system. In response to a second user of the organization performing a predetermined action including searching for a requirement, a posting is generated by the computer searching for a candidate of the organization that could help to resolve the requirement. The computer searches the software module system for at least one supporting user having specific experience related to the requirement and connects the at least one supporting user and the second user.

### TECHNICAL FIELD

The present invention relates to a system and method for technical support and problem solving utilizing collaborative information.

### BACKGROUND

People search the Internet often to obtain help with common and also complex problems. Sometime, solutions do not meet all user requirements and available people and/or experts are not available to help or do not have fresh skills related to the topic of interest.

With an increasing complexity in their environment, solutions and products, large companies expend great resource to have skills built in the most efficient manner and a big part of the resource expenditure is the knowledge sharing among technical experts. It is common for technical personnel to spend many hours looking for certain technical solutions, ranging from simpler coding questions up to very specific security and architecture challenges.

In enterprise systems, one or more users can interact with a base system to perform a number or interactions. The base system may have information to help the users in their work tasks. For example, the user may be an engineer who performs service calls for a number of customers with equipment that have service contracts. The engineer may have a level of expertise in servicing certain types of equipment and may be able to help less-experienced engineers in solving their servicing problems. The experienced engineer may contact the base system for customer information and timing issues related to repairs. However, the less-experienced engineers may need to contact the base system more often for more substantive issues, such as the best approaches on how to service the equipment, and how to tackle problems encountered in their work assignments.

### SUMMARY

A system and method for identifying resources to resolve a requirement is provided. A computer generates an index using user information representative of a predetermined set of actions by a plurality of users of an organization and profile information for the plurality of users. The computer generates a plurality of rich profiles for the plurality of users of the organization based on the index and the user information and stores the index and the rich profiles on a software module system. In response to a second user of the organization performing a predetermined action including searching for a requirement, a posting is generated by the computer searching for a candidate of the organization that could help to resolve the requirement. The computer searches the software module system for at least one supporting user having specific experience related to the requirement. In response to identifying at least one supporting user, the computer connects the at least one supporting user and the second user and sends a notification to each of the supporting user and the second user. The computer then updates a dashboard of a user interface visible to the at least one supporting user, the second user and leaders of the organization.

### BRIEF DESCRIPTION OF THE DRAWINGS

Details of one or more implementations are set forth in the accompanying drawings and the description below. Other features and advantages will be apparent from the description and drawings, and from the claims. Like reference symbols in the various drawings indicate like elements.

FIG. 1 illustrates a schematic showing the data flow relationship between various technicians with respect to a central software module and an artificial intelligence module as they relate to a technician seeking support and an organization leader viewing the various data according to an embodiment of the present invention.

FIG. 2 illustrates an arrangement of virtual communities, software modules, knowledge bases, and knowledge repositories among an enterprise server and multiple client devices according to an embodiment of the present invention.

FIG. 3 is a flowchart showing the interrelation of various technicians and organizational leaders to a software module arrangement of the system according to the present invention.

FIG. 4 is flowchart illustrating the steps of a preferred embodiment of the present invention.

FIG. 5 depicts a block diagram of components of a computing device, in accordance with an illustrative embodiment of the present invention.

FIG. 6 depicts a cloud computing environment, according to an embodiment of the present invention.

FIG. 7 depicts abstraction model layers, according to an embodiment of the present invention.

### DETAILED DESCRIPTION

The present invention creates a connection mechanism for components of an organization (e.g., company, consortium, technical community etc.) to facilitate overcoming of technical challenges consequently increasing the knowledge sharing on such organization. More specifically, the present invention provides a system and method to suggest candidate peers to solve a technical problem by providing a profile of the organization participants, based on previous search terms from the participant; knowledge sharing done through various sources (Publications; Documents sharing on public areas of the organization; Forum post; Social network posts; and Source code being delivered though Source Code Management Systems (such as Git, SVN etc.)) and reputation of the participant.

The passage of time dramatically impacts the strength of knowledge of those experts stored in knowledge and experience databases. Additionally, large organization have no way to track when no solutions within the organization exist for particular issues, topics or problems.

Businesses may utilize more powerful Augmented Intelligence (AI) solutions that can be used to trace technical profiles and connect the right technical team member that will be able to help in the solution finding. The techniques will reduce time to solve such challenges while disseminating the knowledge sharing throughout the organization resulting in a double advantage for organizations adopting this solution.

The system and method include the ability to identify time elapsed between peers who worked on a similar problem; determine the success rate of a contributor or participant by evaluating accuracy of proposed solution, elapsed time and activity. This time component may be computed by using percentage or points. The invention moreover identifies the similarity of the work accomplished to solve a problem and the technical skills associated to it. Additional information may be included in the analysis such as participants' language and time zones.

A dashboard may be provided for organization leaders to follow up the number of connections being created, knowledge transfer being done, recognitions being sent etc.

Expected benefits of the present invention include faster challenges overcome by the overall organization, since organization participants will receive help from specialized members as well as increased knowledge transfer throughout the organization, helping it build the right skills. Moreover, the present invention will increase organization members engagement, since both sides of the connection feels they are participating on a vibrant and connected organization. Additionally, the present invention makes it easy to identify top contributors on the organization and therefore reward them for their contribution.

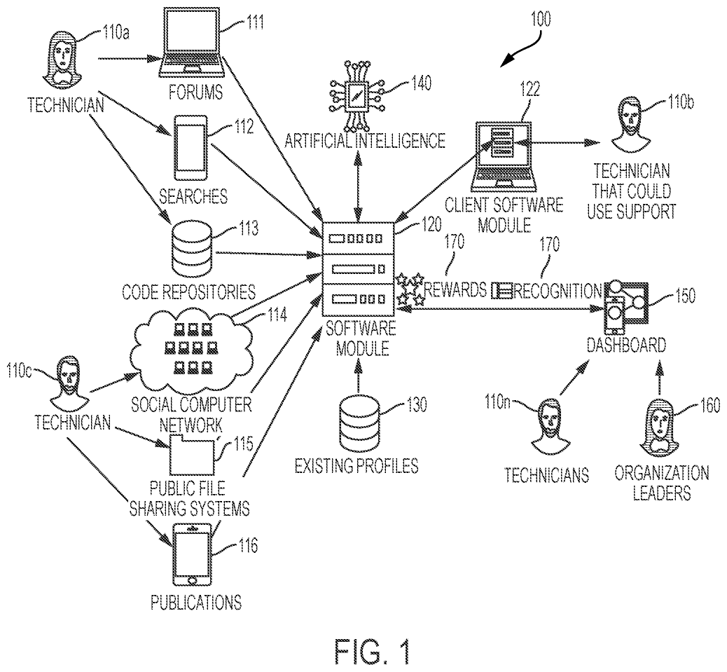

FIG. 1 illustrates a schematic showing the data flow relationship between various technicians with respect to a central software module and an artificial intelligence module as they relate to a technician seeking support and an organization leader viewing the various data. As shown in FIG. 1, a plurality of technicians 110a, 110b, 110c, 110n communicate through various devices with a central software module 120. The technicians 110 may communicate through forums 111, queries 112, code repositories 113, social computer networks 114, public file sharing systems 115, publication 116 as well as a host of other information sources available to those of skill in each particular art. These information sources and conduits are not intended to be exhaustive of the information available to and provided by the various technicians 110. Instead, these examples are provided for illustrative purposes only. The arrows generally indicate the flow of data rather than the action flow.

The software module 120 receives data stored for existing personnel profiles 130 and exchanges information with an artificial intelligence engine or module 140 in the manner described in more detail below.

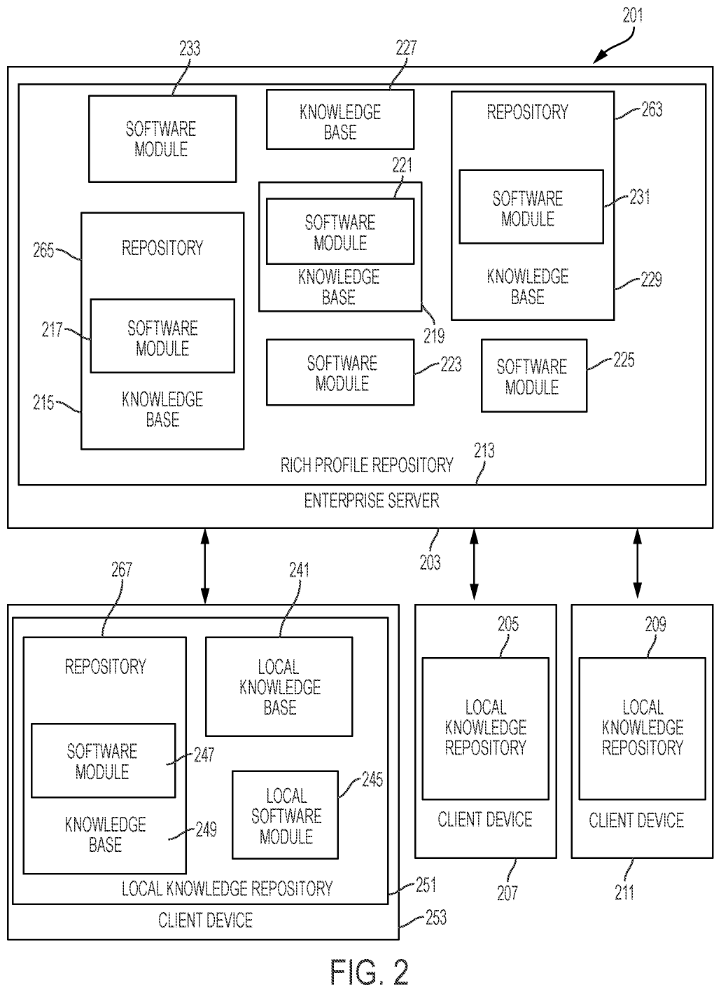

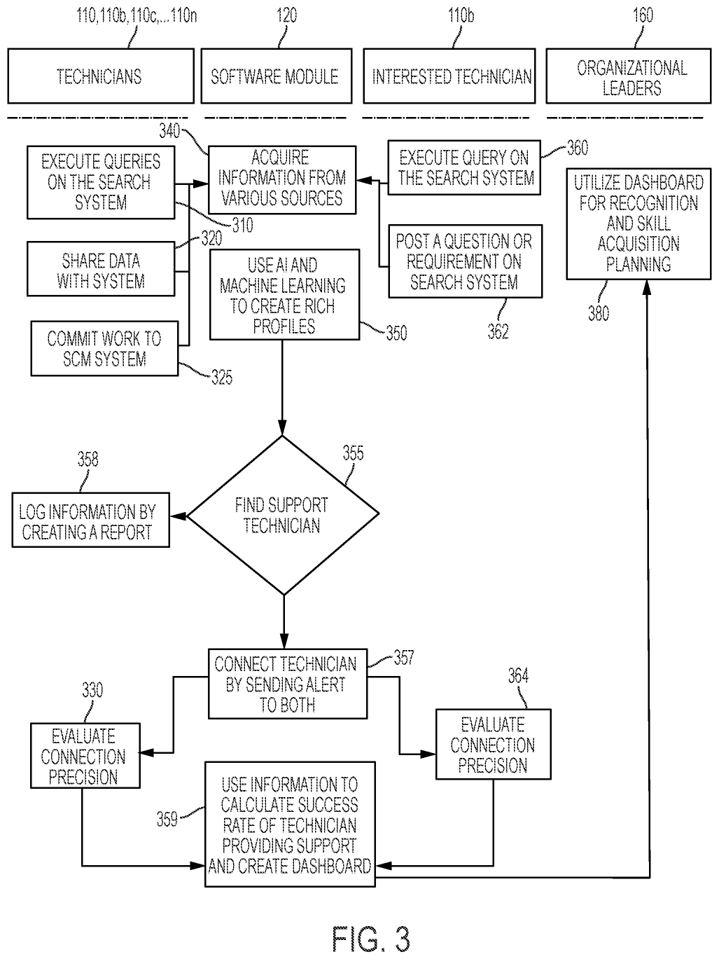

According to the invention, the answer-seeking technician 110b who is in need of support with regard to a specific problem or issue, may access a client software module 122 which is an interface between the answer-seeking technician 110b and software module 120. As described below, the answer-seeking technician 110b may send a request to the system 100 seeking an answer or solution to a specific issue. Alternatively, the system may prompt (e.g., a pop-up window) a user to seek advice or help with a particular solution once the system recognizes that the user is seeking an answer. The results of the request will be compiled by the system 100 and displayed on a dashboard interface that is accessible by other technicians 110n and organization leaders and supervisors 160 in order to obtain snapshot data regarding the success of the answer-seeking technician or the need to enhance the system and/or invest in organizational skill because the request went un-answered. The data compiled or the dashboard 150 further provides a mechanism whereby the organization may provide rewards and recognition (see generally at 170) to those who contributed to solving a problem and contributing to the resolution of an issue. Further detailed regarding the process and steps to accomplish these features will be described below with respect to FIGS. 2 and 3.

The present application describes systems and techniques relating to searching for knowledge in one or more repositories or modules for various topics and problems. In one implementation, a computer program product tangibly embodied in an information carrier includes instructions that, when executed, perform a method to search for information for an expert capable of solving a problem. The method includes receiving a request to solve the problem and searching for a software module in a server to solve the problem. The server is capable of storing information for one or more software modules, and each software module includes information for a business environment or virtual community of experts who are capable of solving the problem.

In another implementation, a system for knowledge elicitation to search for knowledge in a rich profile repository includes a server device with a rich profile repository and a knowledge elicitation engine. The rich profile repository 120 is configured to host multiple software modules, in which each software module includes information for at least one expert to solve a problem. The knowledge elicitation engine is configured to use one or more rules to search for a software module to solve the problem.

In another implementation, a computer program product tangibly embodied in an information carrier has instructions that, when executed, perform a method to search for knowledge in a rich profile repository. The method includes receiving a request to locate information for a solution to a problem and using one or more rules to search among one or more software modules in a rich profile repository 120 to locate a software module associated with the problem. Each of the software modules includes information to solve a problem. The search is based on at least one rule that is related to information for at least one characteristic associated with each of the software modules. The method includes locating a software module using the one or more rules to match the request with the software module, and providing information related to the solution for the problem.

The systems and techniques described here may provide one or more of the following advantages. For example, the system provides a collaborative environment to increase the efficiency of users of the system. The system can identify experts and self-organize experts or technicians 110 for certain problems or topics into groups or virtual communities based on a criterion of the expert, such as experience, quality of work, and performance. Software modules for the problems or topics can be searched for based on information that is resident within the system, and information derived from one or more mobile devices and/or external applications. The information can be accessed by multiple users, including the users of the mobile devices and/or external applications.

One or more users of mobile devices or applications external to an enterprise server can better identify and contact experts to help solve problems. Efficiency may be increased because the problems may be solved collaboratively among a team of experts or technicians 110. Technicians 110 can be searched for and identified at run-time based on one or more criteria of the technicians or users. Users of the system can be better connected to information, and the information can be dynamically updated by any of the users to increase the overall knowledge of the system. In one implementation, the problems may be answered at run-time based on problems that have been previously solved and stored in a rich profile repository 120, so experts may not have to be contacted to address the problem.

In another aspect, information for a software module can be broadcasted to those associated with the software module when new information is available and the knowledge base has been updated with the new information and/or the time-based representation of data with respect to each and/or al technicians 110 becomes relevant to specific issue as determined by the artificial intelligence engine 140 or other component of the software module 120. The multiple users may be users of mobiles devices or external applications with local knowledge repositories that can be updated with information from the rich profile repository. In submitting a search request, users can update their knowledge and information to the rich profile repository.

FIG. 2 shows an exemplary block diagram of components of a knowledge-based system 201 in relation to multiple system users which is an alternate embodiment of the system shown in FIG. 1. The system users may have various roles in a business organization, and the users may use client devices 207, 211, 253 that interact with an enterprise server 203. In accordance with the preferred embodiment of the invention, the users are experts or technicians specializing in a specific field or “art” and they exchange advice, information, and solutions to various problems. The system 201 can create one or more software modules 217, 221, 223, 225, 231, 233, 245, 247 to solve one or more problems. Each of the software modules may include information for a “virtual community” or repository 265, 263, 267 of experts who are capable of solving a problem. Multiple software modules 217, 221, 223, 225, 233, 231 can be stored in a rich profile repository 213 on the enterprise server 203, and run-time searches can be conducted among the various software modules 217, 221, 223, 225, 233, 231 to find one or more experts who can solve the problem. The rich profile repository 213 and enterprise server 203 are intended to be equivalent or comparable to the software modules 120 shown in FIG. 1 and these items may taken many forms as is known to those of skill in the art.

A knowledge base may refer to a collection of domain knowledge or information about a business operation or a business process. The content of the knowledge base can include structured (e.g., attributes/hierarchical attributes), unstructured information (e.g., natural language or procedural codes), or other knowledge representations, such as logic and rules. A software module may refer to a structured representation for an individual's association with a domain of knowledge and the related communications or exchanges of the domain of knowledge among other individuals. A software module can describe the persons associated with the domain knowledge, and how the knowledge is used in an organization. For example, a software module can have a domain of knowledge associated with handling specific engineering problems. The domain of knowledge for the software module can relate to solving a problem or topic. The software module can grow and evolve with information collected during business operations. A software module 233 may or may not be part of a knowledge base, and a knowledge base 227 may or may not include a software module.

The information for the software module can be stored in a set of database tables and/or searchable indexes. The set of database tables can be used to describe the software modules, nodes, linked among nodes, profiles of each individual (a set of databases to represent structured information and free text as unstructured information). Information can be stored in conventional database tables for structured information, and in documents for unstructured information. The information can also be compiled into searchable indexes.

A request may be submitted by a user of a client device (e.g., 207) to an enterprise server 203 for information on one or more experts who can solve the problem or question. The client device may be a mobile device, such as cellphone, PDA (Personal Digital Assistant), wireless handheld, etc. The experts may be identified based on one or more characteristics of the experts, such as experience, quality of work, and performance of work. The request may also be sent by a user of an application that is external to the enterprise server 203.

The enterprise server 203 may have a rich profile repository 213 that interacts with a local knowledge repository 251, 205, 209 residing in each mobile device 253, 207, 211. The rich profile repository 231 can hold various types of data and information on the enterprise server 203. For example, the rich profile repository 231 can store one or more knowledge bases 215, 219, 227, 229, software modules 217, 221, 223, 225, 227, 231, 233, and other types of data (e.g., 265). The information stored in the rich profile repository 231 can relate to a solution database, service orders, sales contracts, product information, and documents.

The local knowledge repositories 251, 205, 209 can store information and data that is similar to the rich profile repository 213. Because the client devices 207, 211, 253 may have less storage capacity than the enterprise server 203 the amount of information stored on each of the client devices is less. In one aspect, the client devices may store only the relevant knowledge or information that is related to the user of the device. As a result, a client device 253 may have a fewer local knowledge bases 241, 249 and software modules 245, 247 than the rich profile repository. The relevant knowledge may be retrieved from the rich profile repository 213 and copied on the local knowledge repository. Alternatively, the local knowledge repository 251 may send new or different information to the rich profile repository 213 for duplication of information on the rich profile repository 213. The local knowledge repository 251 may also store other information, such as database tables and files for user personalization information.

The local knowledge bases 241, 249 can interactively adapt and increase the information stored in the one or more knowledge bases (e.g., 215) in the rich profile repository 213. Mobile device users can prompt for answers to questions while they are out in the field, and receive information stored in repository 265, 263 from the enterprise server 203 for one or more experts in a virtual community who can answer their questions. The virtual community information 265 in a software module 217 in the enterprise server 203 may be duplicated on a client device 253. The virtual community information 265 may have information for a profile of each of the experts as well as the communications and relationships of the experts within the virtual community and/or the company. The profile for the expert may include the experience of the expert, evaluations of the expert work performance and history, the contact information for the expert, notable work contributions of the experts, the role of the expert in an organization, and other attributes of the expert.

Information for an expert may be listed in more than one software module. For example, an electrical engineer may be considered an expert for a chip-technology module related to computer chips, and he/she may also be an expert for a software module related to product information. In another example, a sales representative may be listed based on relationships within a software module. For instance, the sales representative may have been a previous supervisor for a call center agent. If the call center agent is considered an expert within a software module, the previous supervisory status of the sales representative may be listed in an evaluation of the call center agent within the software module information.

In another implementation, a software module may include multiple virtual communities. For example, a software module may relate to customer communication with call center agents. The software module may have a first virtual community for call center agents working with the sale of a product, a second virtual community for call center agents working with the technical support for the product, and a third virtual community for non-technical customer support, such as de-bugging software.

The foregoing disclosure sets forth some general examples for the present invention.

FIG. 3 illustrates a flow sequence and diagram showing the interrelation of different technicians and modules according to an embodiment of the present invention. With reference to FIG. 3 the organization technicians or experts 110a, 110b, 110c, 110n at step 310 will execute various queries on the search engine system 100. The same technicians 110a, 110b, 110c, 110n will share information at step 320 through a plurality of techniques, including: sharing files publicly, post content through organizational networks and/or social networks; and publish articles and/or blogs. Other information sharing techniques may also be employed and these are provided as a set of examples only. The technicians 110 may also at step 325 commit work to source control management systems, such as Git. Git is a version control system for tracking changes in computer files and coordinating work on those files among multiple people. It is primarily used for source code management in software development, but it can be used to keep track of changes in any set of files.

The software module(s) 120 further perform a series of steps as part of the present invention. At step 340, the software modules(s) 120 acquire the content from the devices and content 111-116 (see FIG. 1) at steps 310-325 by, for example, crawling the information with web crawlers, but specific connectors could also be used and the module(s) 120 generates an index with the collected information. A module 120 can also retrieve information from organization members from previously existing profiles stored at database 130 (see FIG. 1).

At step 350, the software module(s) 120 utilizes Machine Learning and AI to create an organization member rich profile that contains at least the following information: (1) expertise areas; (2) job roles; (3) seniority level; (4) latest activity by date/time; (5) previous connections done by the system and the outcome of these previous connections and interacts within the system 100; and a success rate for the technician that may be supporting the solution. The success rate evaluation is a valuable tool for the organization leader 160 and similar management personnel.

Another organization technician, who is need of help or information (here, designated as technician 110b) may perform one of the following actions: a. search for a certain solution (step 360); b. post a question (step 362) c. evaluate connection precision and support received (step 364); d. creates a forum post asking a certain question; e. any other inquiring or research-based activity.

At step 355, the software module will attempt to match the interested technician 110b with one or more of a plurality of users of the system. The software module 120, which knows that the information-seeking technician 110b could use some support to create a solution, tries to find another member of the organization that could help using the AI created profiles. This matching logic may include the following profile information including, but not limited to, previous work done solving a similar problem that the software modules 120 acquired as part of step 340. Therefore, there will be multiple different sources for the software module 120 to verify if a technician worked on a similar solution in the past.

The matching logic further determines an elapsed time threshold for how long in the past a particular member has worked on the same subject. Here, the threshold should be a technician-specific criterion based on previous interactions the technician has gone through. When enough data is available the threshold should also be based on area of expertise for each member, whereby a certain member (or technician 110) might have a higher “memory window” to be able to provide support on an expertise area ‘A’ then on area ‘B’ (which he/she works less frequently on as an example).

In a preferred embodiment, the software module(s) 120 may consider similar work done more recently on related topic as “refreshers” therefore affecting elapsed time calculation as well as a previous success rate calculated for the technician calculated by the feedback given to the software module 120.

In the case there at least one supporting technician found, the software module 120 connects these members and at step 357 send notifications for both the technicians 110 that could provide support and, specifically, the one technician 110b that is looking for support. In the case there is not a supporting technician, the software module 120 logs at step 358 the information to create a report containing the topic(s) where the system 100 did not find a supporting technician. This failure report may be important for mapping skills the organization might be in need of. Similarly, after working on the solution, technicians 110 may evaluate how relevant the returned information was to the connection. The technician 110b, who received support, can provide an evaluation regarding the provided support. The software module 120 further will use the provided information to improve its matching capabilities and to calculate success rate at step 359 for the technicians as it uses AI. At step 330, the system will evaluate the overall connection precision of the overall system 100 based on the success rate and other relevant factors. For example, to determine which possible technicians could help the solution seeker, the cognitive system will calculate the probability of one to be able to help on the given problem based on the following items (but not limited to): (1) success by a technician who has solved a similar problem (based on the collected profile at GitHub, Forum participation, collaboration in technical communities and so on); and (2) using a time factor analysis. For the time factory analysis, the system may monitor a memory window time and/or an elapse time.

Regarding the memory time window, the system will store and recognize if the technician has solved the similar problem in a recent time. The weight on the calculation may be based on an initial standard formula, but the formula will be adjusted as the system collects the success rate for each technician. As an example, the weight for a more recent work is clearly higher than an older one, so the formula could be linear. As time passes, the system could adjust and use a non-linear formula (such as exponential functions, geometric progression, logarithmic functions, and others). Regarding the elapse time, the system will evaluate how much time a particular technician takes to have a similar problem solved (based on previous iterations saved on the system). This approach could be used to enhance the value for faster technicians.

Success rate is an important factor: In one embodiment, the first thing the system calculates is the success rate over the previous similar (expertise-area based) interaction and then the elapsed time for solving the cases (as mentioned above). A given technician will have different success rates varying on many expertise areas (can have a higher success rate when helping someone with problems in Python programming language, but a lower success rate when helping in C # programming language, for instance).

Based on the more important factors above, some other low weight factors could be taken into the calculation: (1) Languages are spoken by both technicians (seeking and providing help); (2) users Profiles, also for both (seeking and providing help); (3) expertise area (Software Developer, IT Architect, Data Scientist, Project Manager), the system could favor the connection when the technicians have the same expertise in some cases; (4) seniority level on the given area or job role: Professionals may have different seniority levels as they could change job roles from time to time. If a data scientist starts to develop, the seniority on a development area will be lower than in data science. So, the different seniority might not be counted; (5) job role (similar to the level above); (6) geographical location.

The software module 120, using the results from the actions above, will update a dashboard at step 380 that can include rewards and recognition pieces. In a preferred embodiment, the dashboard should be visible to both technicians 110 from the organization as well as the leaders 160. The dashboard summary may be beneficial for recognition and skill acquisition planning. An alternative embodiment of the solution is to have a list of technicians that could support the one technician 110b needing help instead of just a single technician.

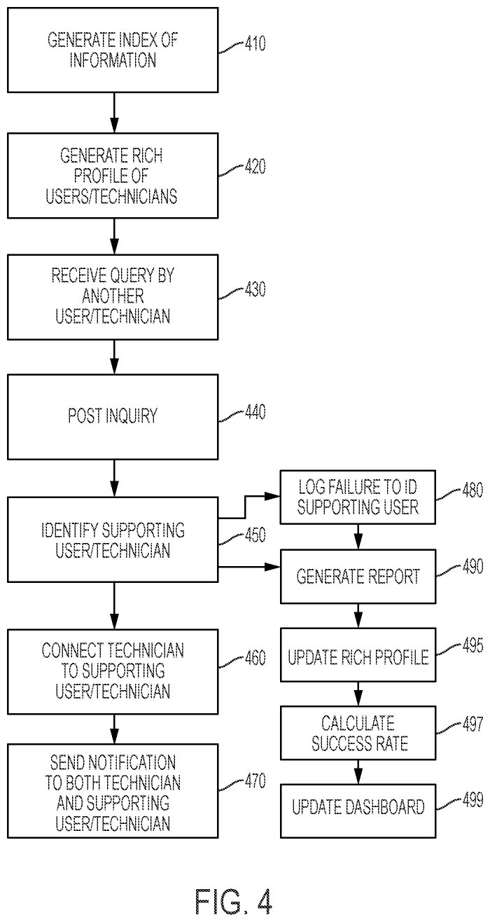

FIG. 4 illustrates a flow chart showing exemplary elements of the method and process of the present invention. With reference to FIG. 4, the method and process is provided for a computer-implemented process for identifying resources to resolve a requirement, whereby the computer-implemented process comprises generating an index using information received to the system. More specifically, in response to receiving information including information representative of a predetermined set of actions by a first user of an organization and profile information for the user, the system 100 generates an index using the information received at step 410.

Next, at step 420, the system 100 generates a rich profile for the user of the organization including, for example, expertise areas, job roles, seniority level, latest activity, previous user connections generated and associated results and a success rate for a respective user of the organization.

When a second user of the organization searches for a particular solution at step 430, the system 100 at step 440 creates a posting including a particular inquiry and a research-based activity, searching for a candidate of the organization that could help to resolve the requirement using the rich profiles. Next, at step 450, the system 100 identifies at least one supporting user who matches or meets the search criteria with an emphasis on a time-based analysis related to the lapse of time since the potential supporting technicians or supporting users have worked on the topic at issue. At step 460, the system 100 connects the at least one supporting user and the second user. At step 470, the system 100 sends a notification to each connected user.

When the system 100 does not identify at least one supporting user, the system 100 logs the search results to create a report at step 480 containing topics that had no supporting user. When the system 100 resolves of the requirement, the system generates at step 490 an evaluation indicating relevance of a connection between the at least one supporting user and the second user. At step 495, the system 100 updates the rich profile for the at least one supporting user and the second user. At step 497, the system 100 calculates a success rate for the at least one supporting user and the second user. Lastly, at step 499; the system updates a dashboard of a user interface visible to the at least one supporting user, the second user and leaders of the organization.

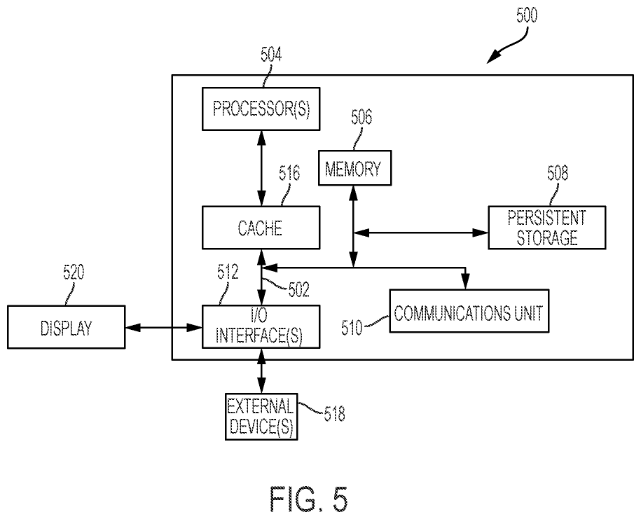

FIG. 5 depicts a block diagram of internal and external components of a computing device, generally designated 500, which is representative of components of FIG. 1, in accordance with an embodiment of the present invention. It should be appreciated that FIG. 8 provides only an illustration of one implementation and does not imply any limitations with regard to the environment in which different embodiments may be implemented. Many modifications to the depicted environment may be made.

Computing device 500 includes communications fabric 502, which provides communications between computer processor(s) 504, memory 506, cache 516, persistent storage 508, communications unit 510, and input/output (I/O) interface(s) 512.

Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM). In general, memory 506 can include any suitable volatile or non-volatile computer readable storage media. Cache 516 is a fast memory that enhances the performance of processors 504 by holding recently accessed data, and data near recently accessed data, from memory 506.

Program instructions and data used to practice embodiments of the present invention may be stored in persistent storage 508 and in memory 506 for execution by one or more of the respective processors 504 via cache 516. In an embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices, including resources of a network. In these examples, communications unit 510 includes one or more network interface cards. Communications unit 510 may provide communications through the use of either or both physical and wireless communications links. Program instructions and data used to practice embodiments of the present invention may be downloaded to persistent storage 508 through communications unit 510.

I/O interface(s) 512 allows for input and output of data with other devices that may be connected to computing device 500. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention (e.g., software and data) can be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor, or a television screen.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

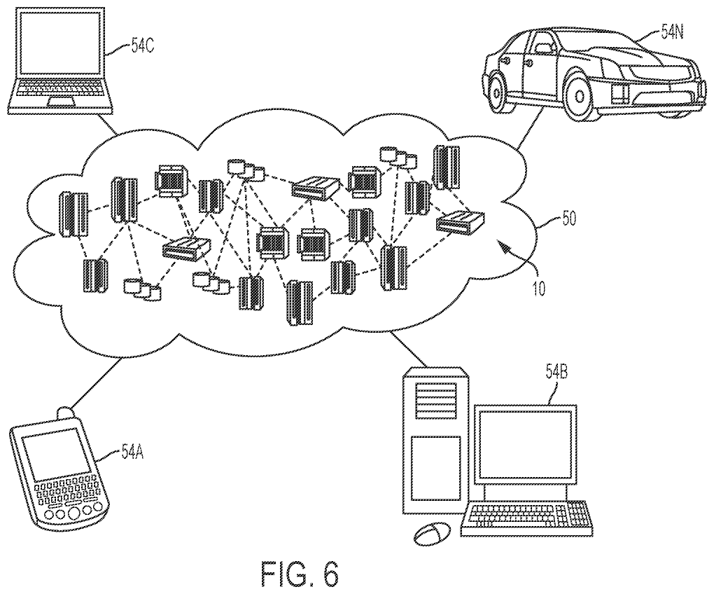

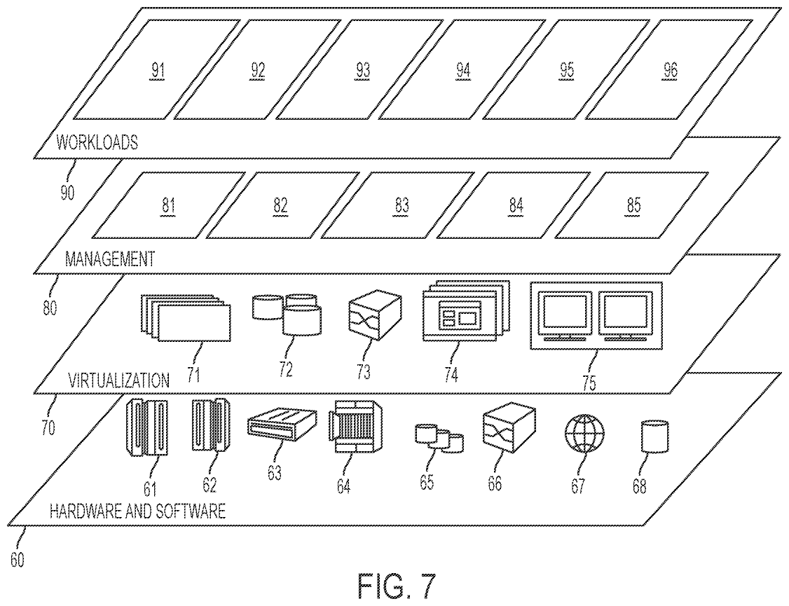

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

Referring now to FIG. 7, a set of functional abstraction layers provided by cloud computing environment 50 (FIG. 5) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and software module(s) 96.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

1. A computer-implemented method, comprising:
generating an index using user information representative of a predetermined set of actions by a plurality of users of an organization and profile information for the plurality of users, said set of actions having a time component to measure a degree of separation said plurality of users have with respect to knowledge related to a plurality of subjects;
generating a plurality of rich profiles for the plurality of users of the organization based on said index and said user information;
storing said index and said rich profiles on a software module system;
in response to a second user of the organization performing a predetermined action including searching for a requirement, creating a posting searching for a candidate of the organization that could help to resolve the requirement;
searching said software module system for at least one supporting user having specific experience related to said requirement, said searching taking into account said time component,
in response to identifying at least one supporting user, ranking said at least one supporting user based on said time component and connecting the at least one supporting user and the second user;
sending a notification to each said supporting user and said second user;
updating a dashboard of a user interface visible to the at least one supporting user, the second user and leaders of the organization.

2. The computer-implemented method as recited in claim 1, further comprising:
tracking specific dates of activity for each of said plurality of users in said index and said rich profile in order to determine an elapse-time threshold indicative of a length of time each said plurality of users has worked on a particular topic.

3. The computer-implemented method as recited in claim 1, further comprising:
sending a message to said plurality of users advising said plurality of users of said posting.

4. The computer-implemented method as recited in claim 1, further comprising:
in response to not identifying the at least one supporting user, logging search results to create a report containing topics that had no supporting user.

5. The computer-implemented method as recited in claim 1, further comprising:
in response to resolution of the requirement, receiving an evaluation indicating relevance of a connection between the at least one supporting user and the second user.

6. The computer-implemented method as recited in claim 5, further comprising:
updating the rich profile for the at least one supporting user and the second user, a matching capability and calculating a success rate for the at least one supporting user and the second user.

7. The computer-implemented method as recited in claim 1, wherein said rich profile includes expertise areas, job roles, seniority level, activity within a predetermined time period, previous user connections, and a success rate for a respective user of the organization;

8. The computer-implemented method as recited in claim 1, wherein said posting including a particular inquiry and a research-based activity.

9. The computer-implemented method as recited in claim 1, wherein said requirement is a particular solution to a particular problem.

10. A computer program product comprising:
a computer-readable storage device; and
a computer-readable program code stored in the computer-readable storage device, the computer readable program code containing instructions executable by a processor of a computer system to implement a method for identifying resources to resolve a requirement, comprising:
generating an index using user information representative of a predetermined set of actions by a plurality of users of an organization and profile information for the plurality of users, said set of actions having a time component to measure a degree of separation said plurality of users have with respect to knowledge related to a plurality of subjects;
generating a plurality of rich profiles for the plurality of users of the organization based on said index and said user information;
storing said index and said rich profiles on a software module system;
in response to a second user of the organization performing a predetermined action including searching for a requirement, creating a posting searching for a candidate of the organization that could help to resolve the requirement;
searching said software module system for at least one supporting user having specific experience related to said requirement, said searching taking into account said time component,
in response to identifying at least one supporting user, ranking said at least one supporting user based on said time component and connecting the at least one supporting user and the second user;
sending a notification to each said supporting user and said second user;
updating a dashboard of a user interface visible to the at least one supporting user, the second user and leaders of the organization.

11. The computer program product as recited in claim 10, further comprising the step of:
tracking specific dates of activity for each of said plurality of users in said index and said rich profile in order to determine an elapse-time threshold indicative of a length of time each said plurality of users has worked on a particular topic.

12. The computer program product as recited in claim 10, further comprising the step of:
sending a message to said plurality of users advising said plurality of users of said posting.

13. The computer program product as recited in claim 10, further comprising:
in response to not identifying the at least one supporting user, logging search results to create a report containing topics that had no supporting user.

14. The computer program product as recited in claim 10, further comprising the step of:
in response to resolution of the requirement, receiving an evaluation indicating relevance of a connection between the at least one supporting user and the second user.

15. The computer program product as recited in claim 14, further comprising the step of:
updating the rich profile for the at least one supporting user and the second user, a matching capability and calculating a success rate for the at least one supporting user and the second user.

16. The computer program product as recited in claim 10, wherein said rich profile includes expertise areas, job roles, seniority level, activity within a predetermined time period, previous user connections, and a success rate for a respective user of the organization;

17. The computer program product as recited in claim 10, wherein said posting including a particular inquiry and a research-based activity.

18. The computer program product as recited in claim 10, wherein said requirement is a particular solution to a particular problem.

19. A computer system, comprising:
a processor;
a memory coupled to said processor; and
a computer readable storage device coupled to the processor, the storage device containing instructions executable by the processor via the memory to implement a method for identifying resources to resolve a requirement, the method comprising the steps of:
generating an index using user information representative of a predetermined set of actions by a plurality of users of an organization and profile information for the plurality of users, said set of actions having a time component to measure a degree of separation said plurality of users have with respect to knowledge related to a plurality of subjects;
generating a plurality of rich profiles for the plurality of users of the organization based on said index and said user information;
storing said index and said rich profiles on a software module system;
in response to a second user of the organization performing a predetermined action including searching for a requirement, creating a posting searching for a candidate of the organization that could help to resolve the requirement;
searching said software module system for at least one supporting user having specific experience related to said requirement, said searching taking into account said time component,
in response to identifying at least one supporting user, ranking said at least one supporting user based on said time component and connecting the at least one supporting user and the second user;
sending a notification to each said supporting user and said second user;
updating a dashboard of a user interface visible to the at least one supporting user, the second user and leaders of the organization.

20. The computer system as recited in claim 19, further comprising the step of:
tracking specific dates of activity for each of said plurality of users in said index and said rich profile in order to determine an elapse-time threshold indicative of a length of time each said plurality of users has worked on a particular topic.
